(19) United States
(12) Patent Application Publication
(10) Pub. No.: US 2011/0029951 A1
(43) Pub. Date: Feb. 3, 2011

(54) Visually Presenting Inherited Members in Object-Oriented Languages

(75) Inventors: Bernhard Jansen, Reuschlikon (CH); Rene A. Pawlitzek, Kilchberg (CH)

Correspondence Address: F. CHAU & ASSOCIATES, LLC;Frank Chau, 130 WOODBURY ROAD, WOODBURY, NY, 11797, US

(73) Assignee: International Business Machines Corporation, Armonk, NY (US)

(21) Appl. No.: 12/512,687

(22) Filed: Jul. 30, 2009

(51) Int. Cl. G06F 9/44

(52) U.S. Cl. 717/113; 717/116

(57) ABSTRACT

A method for visually presenting inherited members in object-oriented languages includes displaying an aggregated view of actual members and inherited members of a current class in a single location.

### BACKGROUND

1. Technical Field

The present disclosure relates to computer programming editing software, and more particularly, to a system and method for presenting a visualization of inherited properties and methods of classes in object-oriented languages.

2. Discussion of Related Art

Object-oriented programming (OOP) is a computer programming concept that allows software developers to use objects to design computer applications. Objects are data structures that comprise members (e.g., properties and methods). Languages supporting OOP include C++, Java and Smalltalk. Inheritance is used in OOP. Classes are arranged in a class hierarchy, and inheritance allows software developers to re-use existing classes when writing new classes. Thus, a class may be specified as a subclass of a parent class. A subclass inherits the properties and methods of the parent class, and can also introduce its own properties and methods. A subclass may also overwrite or modify methods inherited from the parent class.

Known editing programs provide a graphical user interface to assist in the development of programs with languages utilizing OOP. These editing programs typically aid software developers by displaying links to method declarations and inherited classes, as well as showing the respective locations of the declarations and classes in the file system.

Therefore, a need exists for a system and method for visualizing inherited code.

### BRIEF SUMMARY

According to an embodiment of the present disclosure, a method for presenting inherited members in object-oriented languages comprises forming an aggregated view by a processor. The aggregated view comprises at least one actual member of a current class and at least one inherited member of the current class. The aggregated view is displayed in a single location.

According to an embodiment of the present disclosure, a computer-readable medium embodying instructions executed by a processor to perform a method for presenting inherited members in object-oriented languages comprises forming an aggregated view. The aggregated view comprises at least one actual member of a current class and at least one inherited member of the current class. The aggregated view is displayed in a single location.

According to an embodiment of the present disclosure, a system for presenting inherited members in object-oriented languages comprises a plurality of files storing information corresponding to a plurality of classes in a class hierarchy, a model module for creating an aggregated view based on the plurality of classes in the class hierarchy, wherein the aggregated view comprises at least one actual member of a current class and at least one inherited member of the current class, a controller module for updating the model module based on user gestures, and a view module for displaying the aggregated view in a single location.

### BRIEF DESCRIPTION OF THE SEVERAL VIEWS OF THE DRAWINGS

Preferred embodiments of the present disclosure will be described below in more detail, with reference to the accompanying drawings:

FIG. 1 illustrates a class hierarchy and a corresponding editor view of each class in the hierarchy according to an embodiment of the present disclosure.

FIG. 2 illustrates a method of source code unfolding of inherited methods according to an embodiment of the present disclosure.

FIG. 3 illustrates a system for creating an aggregated view showing inherited methods and properties of a displayed class according to an embodiment of the present disclosure.

FIG. 4 is a flowchart illustrating a method of visually presenting inherited members in object-oriented languages according to an embodiment of the present disclosure.

FIG. 5 is a diagram of a computer system for visually presenting inherited members in object-oriented languages according to an embodiment of the present disclosure.

### DETAILED DESCRIPTION

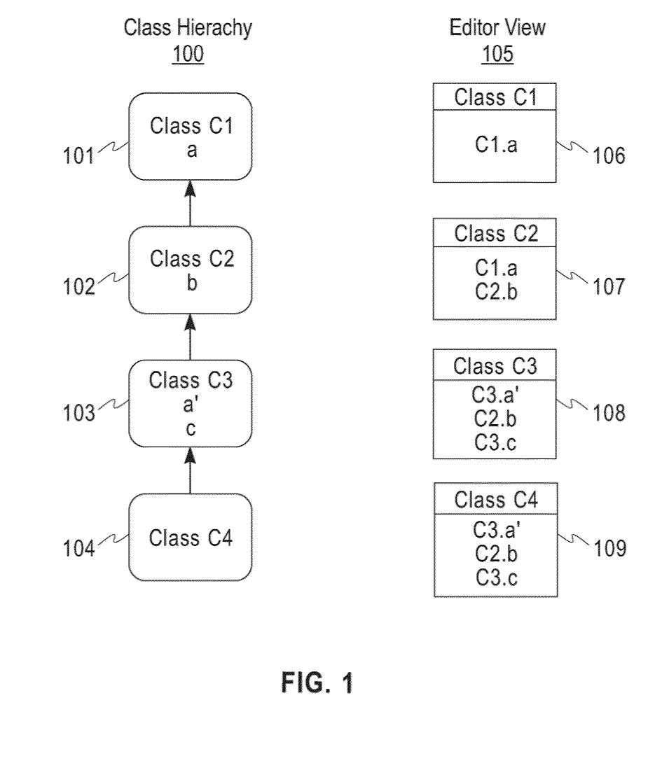

According to an embodiment of the present disclosure, all methods and properties of inherited classes are displayed in a single, aggregated view corresponding to the current subclass. This can be realized by flattening a class hierarchy and displaying the hierarchy in a single location, such that all inherited members (e.g., methods and properties) of the current class are visible at once. For example, FIG. 1 illustrates a class hierarchy 100 and a corresponding editor view 105 for each class in the hierarchy. In order to create the visualization for the editor view 105, source code is parsed and information that can be used to build a data model is extracted. The resulting data model represents the extracted information of the source code and is utilized to create the visualization for the editor view 105. Information extracted from the source code can include information corresponding to the class hierarchy, the class members, and member visibility. The extracted information can be obtained during a design stage of the software (i.e., when the source code is being written).

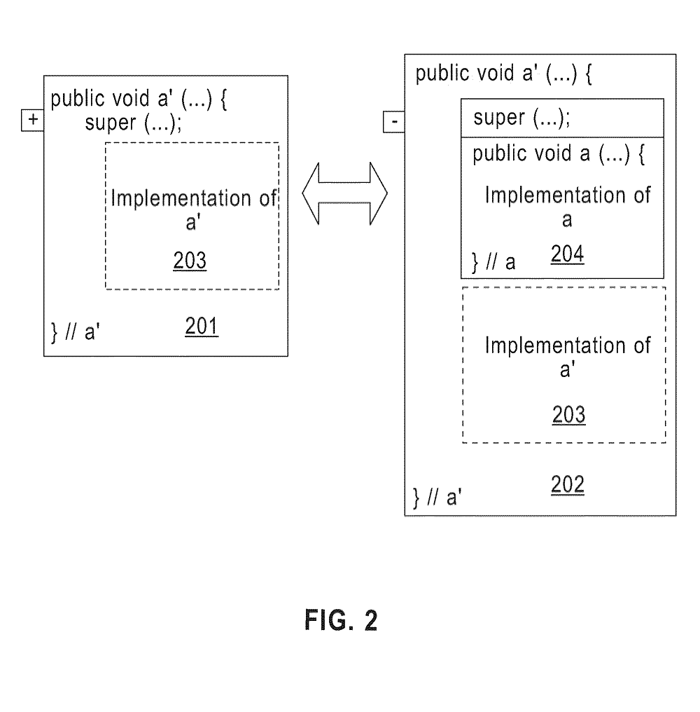

In FIG. 1, Class C1 101 is the highest-level class in the class hierarchy 100. Class C1 101 does not have a parent class and therefore does not inherit any members from other classes. Thus, the only member displayed in the corresponding view 106 for Class C1 101 is a, an actual member of Class C1 101. Class C2 102 is a subclass of Class C1 101 and inherits members of Class C1 101. Thus, the corresponding editor view 107 for Class C2 102 displays b, an actual member of Class C2 102, as well as inherited member a from Class C1 101. Class C3 103 is a subclass of Class C2 102 and inherits members from Class C2 102 and Class C1 101. In addition, Class C3 103 overwrites member a inherited from Class C1 101 with member a′. Thus, the corresponding editor view 108 for Class C3 103 displays a′ and c, actual members of Class C3 103, as well as inherited member b from Class C2 102. Although member a is hidden by member a′ in editor view 108 as a result of being overwritten by Class C3 103, editor view 108 can be unfolded to display the implementation of member a, as illustrated in FIG. 2. Class C4 104 is a subclass of Class C3 103 and inherits members from Class C3 103, Class C2 102 and Class C1 101. However, Class C4 104 does not inherit overwritten members from its parent classes (e.g., member a from Class C1 101 is not inherited). Thus, the corresponding editor view 109 for Class C4 104 displays inherited member a′ from Class C3 103, inherited member c from Class C3 103, and inherited member b from Class C2 102. Although a subclass does not inherit overwritten members from its parent classes, the implementation of an overwritten member may be displayed in an editor view by unfolding the inherited member that overwrote the overwritten member. For example, Class C4 104 does not inherit member a from Class C1 101 because member a was overwritten by member a′ from Class C3 103. However, as illustrated in FIG. 2, inherited member a′ may be unfolded to display the implementation of overwritten member a. Thus, as the editor view at each level of the class hierarchy illustrates, all methods and properties of inherited classes are aggregated and displayed in a single location—the view of the current subclass.

According to an embodiment of the present disclosure illustrated in FIG. 2, the display of inherited members in the editor view can be visually enhanced by hiding source code text with a collapsible visualization. The collapsed view 201 in FIG. 2 depicts an editor view showing inherited method a′ 203, which previously overwrote method a 204. In the collapsed view 201, overwritten method a 204 is not displayed; rather, only inherited method a′ 203, which overwrote method a 204, is presented in the visualization. The collapsed view 201 may be unfolded, resulting in a view 202 displaying both inherited method a′ 203 and overwritten method a 204. Thus, according to the embodiment in FIG. 2, a user has the option of utilizing a collapsed view 201 when a simplified overview of a subclass is needed, or an unfolded view 202 when a more complete visual representation of the entire available functionality of a subclass is desired. An unfolded view 202 may be particularly helpful to a user when class members are modified or overwritten multiple times in super classes.

According to an embodiment of the present disclosure, the representation of inherited methods and properties in the editor view can be visually enhanced further by utilizing different colors or different shades of colors for different inheritance levels. For example, a view of a class inheriting members from all of the classes in the class hierarchy 100 in FIG. 1 may use red when displaying members inherited from Class C1 101, green when displaying members inherited from Class C2 102, blue when displaying members inherited from Class C3 103, and yellow when displaying members inherited from Class C4 104.

According to an embodiment of the present disclosure, filtering options may be provided, allowing a user to configure the level of shown content and inheritance. For instance, a user may utilize filtering options to filter out members of classes from libraries or the run-time environment. For example, referring to FIG. 1, if Class C2 102 is determined to be part of a library or the run-time environment, a user may choose to filter out all members from Class C2 102; thus, views 108 and 109 would not include member C2.b.

According to an embodiment of the present disclosure, for methods that utilize super( ) and overwrite an inherited method, the implementation of the inherited method can be shown inline. This feature works recursively. An additional option can hide the source code for the super implementation. This is illustrated in FIG. 2. Further, to support visualization, coloring or different shades of colors can be used for the source code text of the super implementation.

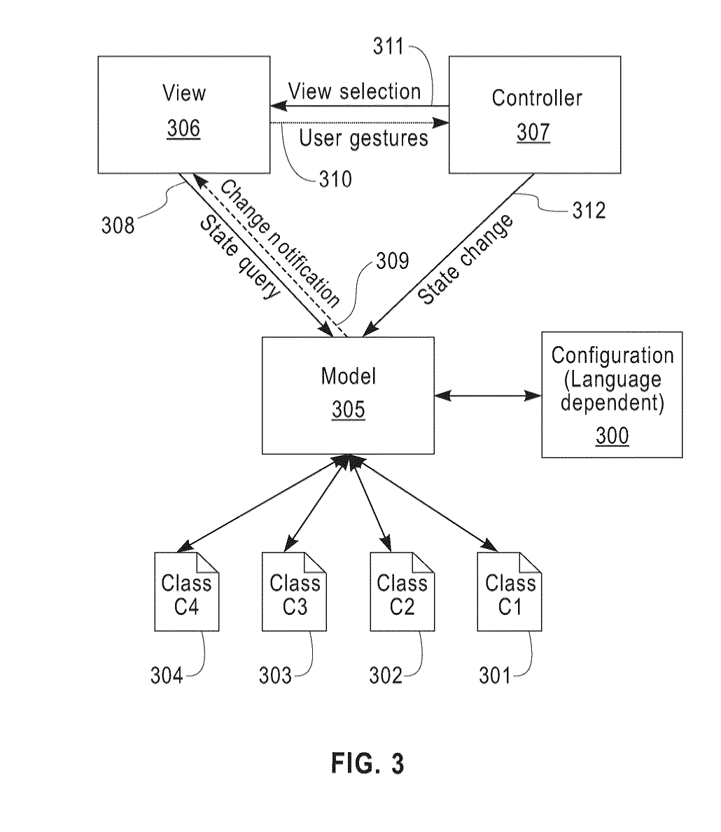

FIG. 3 illustrates an embodiment of the present disclosure utilizing a model-view-controller (MVC) design to implement a system for creating an aggregated view showing all inherited methods and properties of a displayed class. According to the embodiment, a view of a current, displayed class is created based on information corresponding to a plurality of classes, rather than information corresponding only to the displayed class itself. For example, referring to FIG. 1, a view of Class C4 109 is created based on information corresponding to Classes C4 104, C3 103, C2 102, and C1 101; the view is not created based solely on information corresponding to Class C4 104. In FIG. 3, information corresponding to each class is stored separately in different files 301, 302, 303, 304 in the system. The model 305 in the system is used for maintaining data, and has access to all information (e.g., files 301, 302, 303, 304) that is needed to create the view 306. The model 305 is configured by configuration module 300, which is dependent on the programming language of the source code. The view 306 displays an aggregated view of the current, displayed class, which comprises information from all related classes. For example, view 109 in FIG. 1, which is a visual representation of Class C4 104, comprises information corresponding to classes C4 104, C3 103, C2 102, and C1 101. The view 306 queries 308 the model 305 prior to displaying data, and the model 305 notifies 309 the view 306 of any relevant changes made subsequent to displaying a visualization. The controller 307 handles events that affect the model 305 or the view 306. Specifically, the controller 307 responds to user gestures 310 and is responsible for making the appropriate view selection 311. Changes 312 made to the view 306 by the user may have an effect on related classes that contribute to the aggregated view, and the controller 307 applies these changes 312 to the model 305. These changes to the model 312 are automatically made by the system and are transparent to the user.

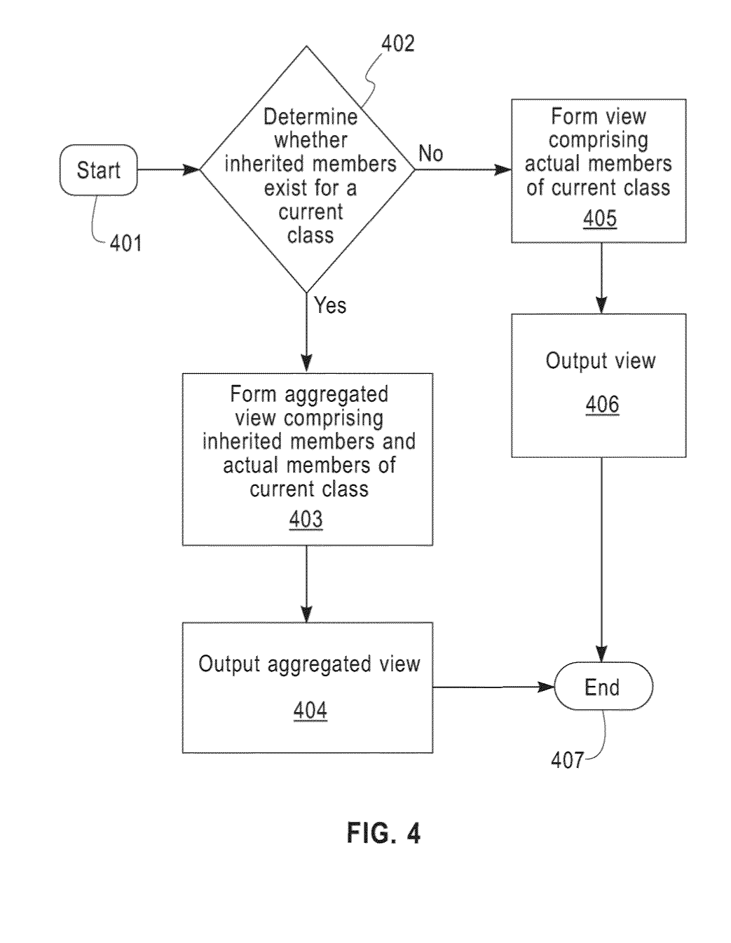

FIG. 4 illustrates the general steps of a method for visually presenting inherited members in object-oriented languages according to an embodiment of the present disclosure. At block 402, it is determined whether inherited members exist for a current class. If the current class has inherited members, an aggregated view comprising the inherited members and the actual members of the current class is formed at block 403 and this aggregated view is output at block 404. If the current class does not have inherited members, a view is formed comprising the actual members of the current class at block 405 and this view is output at block 406.

According to an embodiment of the present disclosure, the system and method described herein may be implemented via stand-alone software or via an editor extension. Further, it is to be appreciated that embodiments of the present disclosure may be utilized with software having editing functionality, as well as software having only viewing functionality.

Exemplary embodiments of the present disclosure may be realized taking into consideration implementation-specific decisions to achieve a specific goal(s), such as compliance with system-related and business-related constraints. Moreover, it will be appreciated that such a development effort might be complex and time-consuming, but would nevertheless be a routine undertaking for those of ordinary skill in the art having the benefit of this disclosure.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to exemplary embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is to be understood that embodiments of the present disclosure may be implemented in various forms of hardware, software, firmware, special purpose processors, or a combination thereof. In one embodiment, a method for low complexity signal analysis may be implemented in software as an application program tangibly embodied on a computer readable medium. The application program may be uploaded to, and executed by, a processor comprising any suitable architecture.

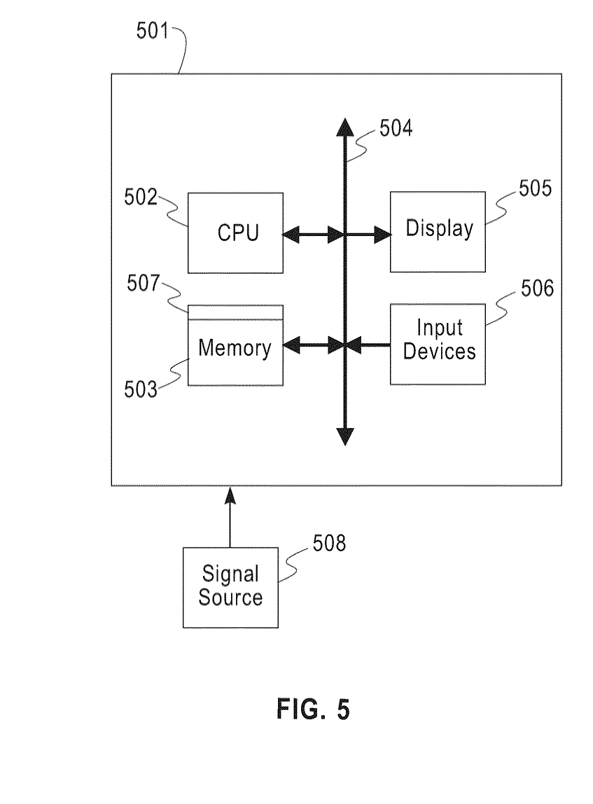

Referring to FIG. 5, according to an embodiment of the present disclosure, a computer system 501 for visually presenting inherited members in object-oriented languages can comprise, inter alia, a central processing unit (CPU) 502, a memory or computer readable medium 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. Exemplary embodiments of the present disclosure can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present disclosure.

The computer platform 501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner of programming. Given the teachings of the present disclosure provided herein, one of ordinary skill in the related art will be able to contemplate these and similar implementations or configurations.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described exemplary embodiments for a system and method for visually presenting inherited members in object-oriented languages, it is noted that modifications and variations can be made by persons skilled in the art in light of the above teachings. It is therefore to be understood that changes may be made in embodiments of the present disclosure which are within the scope and spirit of the disclosure as defined by the appended claims. Having thus described the disclosure with the details and particularity required by the patent laws, what is claimed and desired protected by Letters Patent is set forth in the appended claims.

What is claimed is:

1. A method for presenting inherited members in object-oriented languages, comprising:
forming an aggregated view, by a processor, comprising at least one actual member of a current class and at least one inherited member of the current class; and
displaying the aggregated view in a single location.

2. The method of claim 1, further comprising forming and displaying a collapsible visualization comprising the at least one inherited member of the current class.

3. The method of claim 2, wherein the collapsible visualization further comprises at least one of a modified member and an overwritten member.

4. The method of claim 1, further comprising displaying different inheritance levels of the current class having different colors.

5. The method of claim 1, further comprising filtering the at least one inherited member of the current class.

6. The method of claim 5, wherein filtering comprises one of filtering members of classes from a library and filtering members of classes from a run-time environment.

7. A computer-readable medium embodying instructions executed by a processor to perform a method for presenting inherited members in object-oriented languages, comprising:
forming an aggregated view comprising at least one actual member of a current class and at least one inherited member of the current class; and
displaying the aggregated view in a single location.

8. The computer-readable medium of claim 7, further comprising forming and displaying a collapsible visualization comprising the at least one inherited member of the current class.

9. The computer-readable medium of claim 8, wherein the collapsible visualization further comprises at least one of a modified member and an overwritten member.

10. The computer-readable medium of claim 7, further comprising displaying different inheritance levels of the current class having different colors.

11. The computer-readable medium of claim 7, further comprising filtering the at least one inherited member of the current class.

12. The computer-readable medium of claim 11, wherein filtering comprises one of filtering members of classes from a library and filtering members of classes from a run-time environment.

13. A system for presenting inherited members in object-oriented languages, comprising:
a plurality of files, stored to a memory device, storing information corresponding to a plurality of classes in a class hierarchy;
a model module executed by a processor for creating an aggregated view based on the plurality of files, wherein the aggregated view comprises at least one actual member of a current class and at least one inherited member of the current class;
a controller module executed by the processor for updating the model module based on user gestures; and
a view module executed by the processor for displaying the aggregated view in a single location.

14. The system of claim 13, wherein the model module executed by the processor creates a collapsible visualization comprising the at least one inherited member of the current class.

15. The system of claim 14, wherein the collapsible visualization further comprises at least one of a modified member and an overwritten member.

16. The system of claim 13, wherein different colors represent different inheritance levels of the current class.

17. The system of claim 13, wherein at least one inherited member of the current class is filtered from the current class.

18. The system of claim 17, wherein filtering comprises one of filtering members of classes from a library and filtering members of classes from a run-time environment.
